(19) United States
(12) Patent Application Publication
(10) Pub. No.: US 2025/0148662 A1
(43) Pub. Date: May 8, 2025

(54) METHODS AND APPARATUS FOR DEEP LEARNING BASED IMAGE RECONSTRUCTION

(71) Applicants: Siemens Medical Solutions USA, Inc., Malvern, PA (US); The Trustees of The University of Pennsylvania, Philadelphia, PA (US)

(72) Inventors: Deepak Bharkhada, Knoxville, TN (US); Vladimir Panin, Knoxville, TN (US); Mael Millardet, Knoxville, TN (US)

(21) Appl. No.: 18/502,338

(22) Filed: Nov. 6, 2023

(51) Int. Cl. G06T 11/00

(52) U.S. Cl. CPC G06T 11/006; G06T 2210/41; G06T 2211/441

(57) ABSTRACT

Systems and methods for training end-to-end deep learning reconstruction processes, and for reconstructing medical images based on the trained deep learning processes, are disclosed. In some examples, input projection data is received. An untrained machine learning process is applied to the input projection data and, based on the application of the machine learning process to the projection data, an output image is generated. Further, a forward projection process is applied to the output image and, based on the application of the forward projection process to the output image, forward projected image data is generated. A loss value is then determined based on the forward projected image data and the input projection data. The loss value is then compared to a threshold value to determine whether the machine learning process is trained. The trained machine learning process may be employed to reconstruct images, such as positron emission tomography (PET) images.

This invention was made with government support under EB031806 awarded by the National Institutes of Health. The government has certain rights in the invention.

### FIELD

Aspects of the present disclosure relate in general to medical diagnostic systems and, more particularly, to reconstructing images from nuclear imaging systems for diagnostic and reporting purposes.

### BACKGROUND

Nuclear imaging systems can employ various technologies to capture images. For example, some nuclear imaging systems employ positron emission tomography (PET) to capture images. PET is a nuclear medicine imaging technique that produces tomographic images representing the distribution of positron emitting isotopes within a body. Some nuclear imaging systems employ computed tomography (CT), for example, as a co-modality. CT is an imaging technique that uses x-rays to produce anatomical images. Magnetic Resonance Imaging (MRI) is an imaging technique that uses magnetic fields and radio waves to generate anatomical and functional images. Some nuclear imaging systems combine images from PET and CT scanners during an image fusion process to produce images that show information from both a PET scan and a CT scan (e.g., PET/CT systems). Similarly, some nuclear imaging systems combine images from PET and MRI scanners to produce images that show information from both a PET scan and an MRI scan.

Typically, these nuclear imaging systems capture measurement data, and process the captured measurement data using mathematical algorithms to reconstruct medical images. For example, reconstruction can be based on machine learning models, such as machine learning models based on deep learning algorithms. Typically, the machine learning models are trained and, once trained to a target degree, are employed in practice to diagnose patients. Even after robust training, however, the machine learning models can maintain algorithmic biases that lead to errors (e.g., hallucinations) within reconstructed images. As such, there are opportunities to address these and other deficiencies in nuclear imaging systems.

### SUMMARY

Systems and methods for training deep learning processes, and for reconstructing medical images based on the trained deep learning processes, are disclosed.

In some embodiments, a computer-implemented method includes receiving input projection data (e.g., projection data in the form of histo-images). The method also includes applying a machine learning process to the input projection data and, based on the application of the machine learning process to the input projection data, generating output image data (e.g., an output image). Further, the method includes applying a forward projection process to the output image data and, based on the application of the forward projection process to the output image data, generating forward projected image data. The method also includes determining a loss value based on the forward projected image data and the input projection data. The method further includes determining the machine learning process is trained based on the loss value. The method also includes storing parameters associated with the machine learning process in a data repository.

In some embodiments, a non-transitory computer readable medium stores instructions that, when executed by at least one processor, cause the at least one processor to perform operations including receiving input projection data. The operations also include applying a machine learning process to the input projection data and, based on the application of the machine learning process to the input projection data, generating output image data. Further, the operations include applying a forward projection process to the output image data and, based on the application of the forward projection process to the output image data, generating forward projected image data. The operations also include determining a loss value based on the forward projected image data and the input projection data. The operations further include determining the machine learning process is trained based on the loss value. The operations also include storing parameters associated with the machine learning process in a data repository.

In some embodiments, a system includes a data repository and at least one processor communicatively coupled the data repository. The at least one processor is configured to receive input projection data. The at least one processor is also configured to apply a machine learning process to the input projection data and, based on the application of the machine learning process to the input projection data, generating output image data. Further, the at least one processor is configured to apply a forward projection process to the output image data and, based on the application of the forward projection process to the output image data, generate forward projected image data. The at least one processor is also configured to determine a loss value based on the forward projected image data and the input projection data. The at least one processor is further configured to determine the machine learning process is trained based on the loss value. The at least one processor is also configured to store parameters associated with the machine learning process in the data repository.

### BRIEF DESCRIPTION OF THE DRAWINGS

The following will be apparent from elements of the figures, which are provided for illustrative purposes and are not necessarily drawn to scale.

FIG. 1 illustrates a nuclear image reconstruction system, in accordance with some embodiments.

FIG. 2 illustrates a block diagram of an example computing device that can perform one or more of the functions described herein, in accordance with some embodiments.

FIG. 3 illustrates a nuclear imaging system that trains machine learning processes, in accordance with some embodiments.

FIG. 4 illustrates a system that trains a machine learning process based on sinogram data, in accordance with some embodiments.

FIGS. 5A and 5B illustrate a system that trains a machine learning process based on histo-image data, in accordance with some embodiments.

FIG. 6 is a flowchart of an example method to train a neural network based on image data, in accordance with some embodiments.

FIG. 7 is a flowchart of another example method to train a neural network based on image data, in accordance with some embodiments.

### DETAILED DESCRIPTION

This description of the exemplary embodiments is intended to be read in connection with the accompanying drawings, which are to be considered part of the entire written description. Independent of the grammatical term usage, individuals with male, female, or other gender identities are included within the term.

The exemplary embodiments are described with respect to the claimed systems as well as with respect to the claimed methods. Furthermore, the exemplary embodiments are described with respect to methods and systems for image reconstruction, as well as with respect to methods and systems for training functions used for image reconstruction. Features, advantages, or alternative embodiments herein can be assigned to the other claimed objects and vice versa. For example, claims for the providing systems can be improved with features described or claimed in the context of the methods, and vice versa. In addition, the functional features of described or claimed methods are embodied by objective units of a providing system. Similarly, claims for methods and systems for training image reconstruction functions can be improved with features described or claimed in context of the methods and systems for image reconstruction, and vice versa.

Various embodiments of the present disclosure can employ machine learning methods or processes to provide clinical information from nuclear imaging systems. For example, the embodiments can employ machine learning methods or processes to reconstruct images based on captured measurement data, and provide the reconstructed images for clinical diagnosis. In some embodiments, machine learning methods or processes are trained, to improve the reconstruction of images.

End-to-end deep learning image reconstruction has gained interest in recent years. However, a recurring problem with current methods is their tendency to hallucinate certain parts of the image. These hallucinations can create (or remove) a tumor out of thin air. As the image appears of good quality, these hallucinations can give physicians a false sense of confidence in the images, which can lead to subpar diagnosis or even misdiagnosis. The embodiments described herein may address these and other image reconstruction issues and drawbacks.

In some embodiments, a machine learning model (e.g., machine learning algorithm), such as a neural network, is trained based on projection data. For instance, the machine learning model may be trained based on projection data in the form of histo-images. The histo-images may be generated based on sinogram data generated by a Positron Emission Tomography (PET) scanning system, for instance. The machine learning model may be trained with multiple epochs of projection data. To train the machine learning model, features may be generated based on the projection data, and the generated features may be input into the machine learning model. Based on the inputted features, the machine learning model may generate output image data (e.g., an output image). For example, based on the inputted features, one or more input values and one or more output values may be computed for each of multiple layers of the machine learning model, and the output image data may characterize the final output of the machine learning model, which may be a reconstructed image (e.g., a reconstructed PET image).

Further, a forward projection process may be applied to the output image data and, based on the forward projection process, forward projection image data may be generated. The forward projection image data may characterize a forward projected histo-image, for instance. For example, the output image data may be input to a forward projection model. Based on the inputted output image data, the forward projection model may generate forward projection image data characterizing a forward projected image. The forward projection model may be, for instance, a point-projection model, a convex-disk model, an area-weighted model, a Gaussian blobs model, a line-length model, a Rotation-based projection model, or any other suitable forward project model (e.g., physics model). In some examples, the forward projection model is a deep learning model that has learned to forward project image data.

Additionally, a loss may be determined based on the projection data (e.g., input histo-images) and the forward projection image data (e.g., forward projected histo-images). The loss may be computed based on any suitable loss function (e.g., image reconstruction loss function), such as any of the mean square error (MSE), mean absolute error (MAE), binary cross-entropy (BCE), Sobel, Laplacian, and Focal binary loss functions. A determination may be made as to whether the machine learning model is trained based on the computed loss. For instance, if the computed loss at least meets (e.g., exceeds, is below) a corresponding loss threshold, then a determination is made that the machine learning model is trained. Otherwise, if the computed loss does not at least meet the corresponding threshold, a determination is made that the machine learning model is not trained. In this case, the machine learning model may be trained with further epochs of image data until the loss does at least meet the corresponding threshold. Once trained, the machine learning model may be employed by image reconstruction systems to reconstruct images, for instance.

In some embodiments, an additional loss is computed. The additional loss may be computed based on the output image data generated by the executed machine learning model. and second output image data generated from an already trained machine learning model (i.e., the second machine learning model). The already trained machine learning model may be, for example, a trained convolutional neural network, such as a convolutional neural network conventionally trained. In these examples, a determination is made as to whether the in-training machine learning model (i.e., the first machine learning model) is trained based on two computed losses—the original loss (computed based on the projection data and the forward projection image data) and the additional loss (computed based on the projection data and the second output image data generated from the already trained machine learning model). For example, if the original loss and the additional loss each at least meet corresponding loss thresholds, then a determination is made that the machine learning model is trained. Otherwise, if any of the original loss and the additional loss do not at least meet their corresponding thresholds, a determination is made that the machine learning model is not trained. In this case, the machine learning model may be trained with further epochs of image data until the original loss and the additional loss do at least meet their corresponding thresholds. Once trained, the machine learning model may be employed by image reconstruction systems to reconstruct images, for instance.

In some embodiments, as described herein, the machine learning model may be validated based on additional epochs of image data. If the machine learning model validates, the machine learning model may be employed by image reconstruction systems to reconstruct images, for instance. Otherwise, if the machine learning model does not validate, then the machine learning model may be further trained as described herein. Further, in some embodiments, the machine learning model may be trained on image data and co-modality data, such as attenuation maps generated from CT or MR imaging. For instance, features may be generated based on the projection data and the co-modality data, and may be inputted to any of the machine learning models described herein during training to generate the corresponding output image data.

Additionally, as described herein, in some embodiments the projection data may be histo-image data (e.g., histo-images in histo-image space). For instance, a histogrammer (e.g., an executed histogram algorithm) may generate the histo-image data based on PET measurement data received from an image scanning system, such as PET image scanner. Further, features may be generated based on the histo-image data (and, in some examples, co-modality data), and may be inputted to any of the machine learning models described herein to generate output histo-image data. The forward projection processes described herein may be applied to the inputted histo-image data and the outputted histo-image data to generate forward projection data. As described herein, a loss may be computed based on the forward projection data and the histo-image data. The machine learning model may be considered trained with the computed loss at least meets a corresponding threshold.

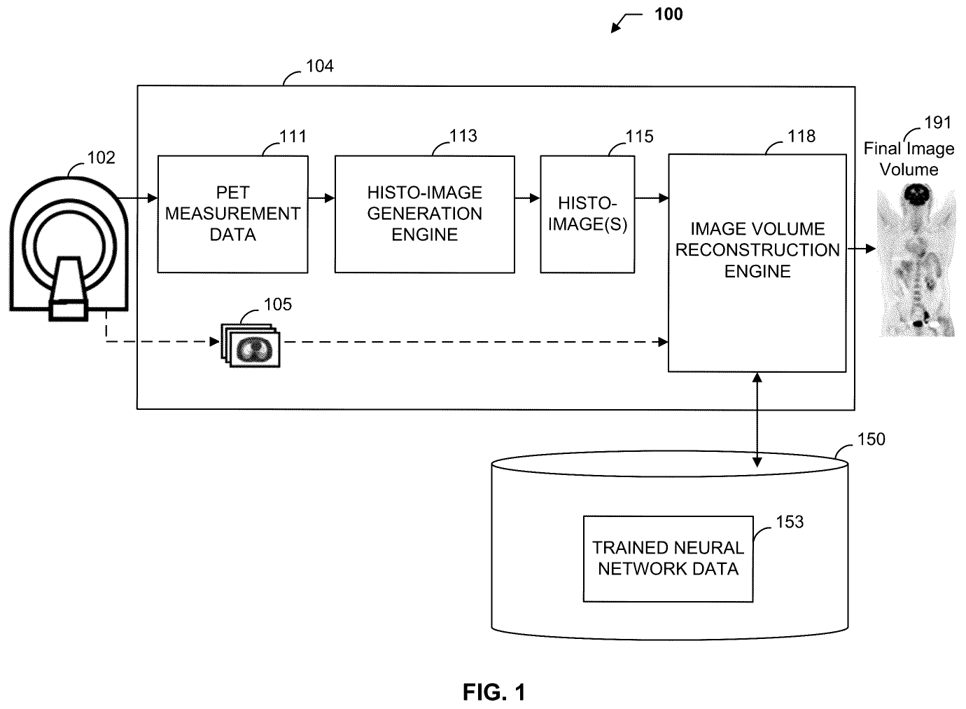

FIG. 1 illustrates a nuclear imaging system 100 that includes image scanning system 102 and image reconstruction system 104. Image scanning system 102 may be PET scanner that can capture PET images, a PET/MR scanner that can capture PET and MR images, a PET/CT scanner that can capture PET and CT images, or any other suitable image scanner. For example, as illustrated, image scanning system 102 can capture PET images (e.g., of a person), and can generate PET measurement data 111 (e.g., PET raw data, such as sinogram data) based on the captured PET images. The PET measurement data 111 (e.g., list mode data) can represent anything imaged in the scanner's field-of-view (FOV) containing positron emitting isotopes. For example, the PET measurement data 111 can represent whole-body image scans, such as image scans from a patient's head to thigh. Further, image scanning system can transmit the PET measurement data 111 to image reconstruction system 104 (e.g., over one or more wired or wireless communication busses).

In some examples, image scanning system 102 may additional generate attenuation maps 105 (e.g., μ-maps). For instance, the attenuation map 105 may be based on a separate scan of the patient without receiving radiotracer injections. In other examples, the image scanning system 102 may be a PET/CT scanner that, in addition to PET images, can capture CT scans of the patient. The image scanning system 102 may generate the attenuation maps 105 based on the captured CT images, and may transmit the attenuation maps 105 to the image reconstruction system 104. As another example, the image scanning system 102 may be a PET/MR scanner that, in addition to PET images, can capture MR scans of the patient. The image scanning system 102 may generate the attenuation maps 105 based on the captured MR images, and may transmit the attenuation maps 105 to the image reconstruction system 104.

Further, in some examples, all or parts of image reconstruction system 104 are implemented in hardware, such as in one or more field-programmable gate arrays (FPGAs), one or more application-specific integrated circuits (ASICs), one or more state machines, one or more computing devices, digital circuitry, or any other suitable circuitry. In some examples, parts or all of image reconstruction system 104 can be implemented in software as executable instructions such that, when executed by one or more processors, cause the one or more processors to perform respective functions as described herein. The instructions can be stored in a non-transitory, computer-readable storage medium, and can be read and executed by the one or more processors.

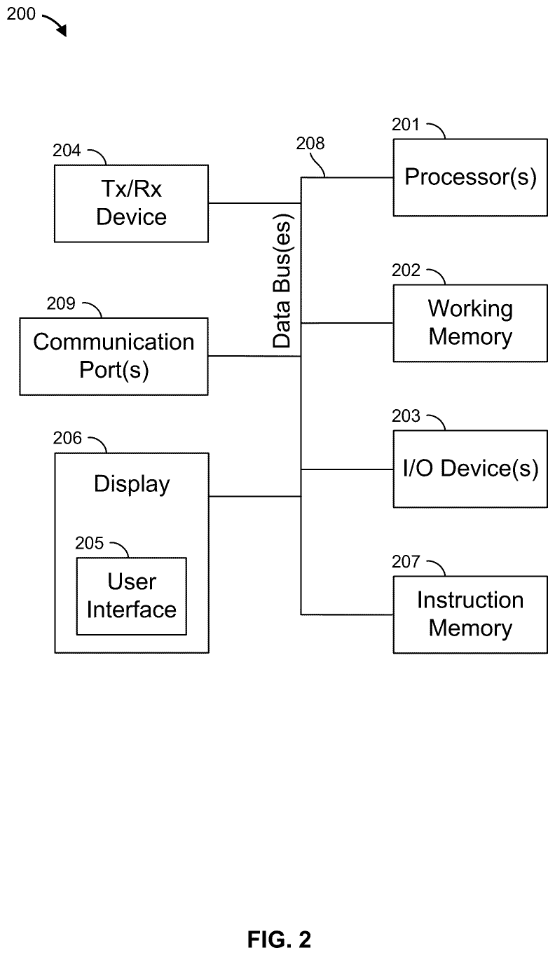

FIG. 2, for example, illustrates a computing device 200 that can be employed by the image reconstruction system 104. Computing device 200 can implement one or more of the functions of the image reconstruction system 104 described herein.

Computing device 200 can include one or more processors 201, working memory 202, one or more input/output devices 203, instruction memory 207, a transceiver 204, one or more communication ports 209, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. For example, instruction memory 207 can store instructions that, when executed by one or more processors 201, cause one or more processors 201 to perform one or more of the functions of image reconstruction system 104, such as one or more of the machine learning processes and/or forward projection processes described herein.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of computing device 200. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as PET measurement data 111 and/or attenuation maps 105.

Display 206 can display user interface 205. User interfaces 205 can enable user interaction with computing device 200. For example, user interface 205 can be a user interface for an application that allows for the viewing of final image volumes 191. In some examples, a user can interact with user interface 205 by engaging input-output devices 203. In some examples, display 206 can be a touchscreen, where user interface 205 is displayed on the touchscreen.

Transceiver 204 allows for communication with a network, such as a Wi-Fi network, an Ethernet network, a cellular network, or any other suitable communication network. For example, if operating in a cellular network, transceiver 204 is configured to allow communications with the cellular network. Processor(s) 201 is operable to receive data from, or send data to, a network via transceiver 204.

Referring back to FIG. 1, image reconstruction system 104 includes histo-image generation engine 113, and image volume reconstruction engine 118. One or more of histo-image generation engine 113 and image volume reconstruction engine 118 may be implemented in hardware (e.g., digital logic), as by one or more processors, such as processor 201, executing instructions, or in any combination thereof. Histo-image generation engine 113 operates on PET measurement data 111 to generate histo-images 115. Histo-image generation engine 113 can generate histo-images 115 based on corresponding PET measurement data 111 using any suitable method known in the art.

Further, image volume reconstruction engine 118 receives each histo-image 115 and applies one or more machine learning processes to the histo-image 115 to reconstruct a corresponding final image volume 191. In some examples, image volume reconstruction engine 118 also receives an attenuation map 105 corresponding to the histo-image 115, and applies the one or more machine learning processes (e.g., deep learning processes) to the histo-image 115 and the attenuation map 105 to generate the final image volume 191. For instance, image volume reconstruction engine 118 may parse the attenuation map 105 to extract attenuation correction values, and adjusts corresponding values within histo-image 115 to generate final image volume 191. Final image volume 191 is a “corrected” PET image. Further, image reconstruction system 104 may provide the final image volume 191 for display and analysis, for example.

As described herein, applying the machine learning processes to the histo-images 115 and, in some examples, the corresponding attenuation maps 105, includes generating features based on the histo-images 115 and/or the attenuation maps 105, and inputting the generated features to a trained machine learning model, such as a convolutional neural network. Based on the inputted features, the trained machine learning model outputs the final image volume 191.

To establish the trained machine learning model, the image reconstruction system 104 may obtain, from data repository 150, trained neural network data 153, which includes parameters (e.g., hyperparameters, coefficients, weights, etc.) characterizing the trained machine learning model. For example, the image reconstruction system 104 may configure an executable machine learning model (e.g., executable instructions characterizing a machine learning model) based on (e.g., with) the parameters of the trained neural network data 153 to establish a trained machine learning model.

To determine the parameters of the trained neural network data 153, the machine learning model is trained. For example, and as described herein, the image reconstruction system 104 may obtain a training set of image data, such as one or more epochs of sinogram data, from data repository 150. Further, image reconstruction system 104 may generate features based on the training set of data, and input the features into an executed untrained machine learning model. Based on the inputted features, the executed untrained machine learning model may generate output image data characterizing a reconstructed image (e.g., a reconstructed PET image).

Further, image reconstruction system 104 may apply a forward projection process to the output image data and, based on the application of the forward projection process, may generate forward projection image data characterizing forward projected images. For instance, as described herein, image reconstruction system 104 may input the output image data generated by the executed untrained machine learning model to a forward projection model. Based on the inputted output image data, the forward projection model may generate forward projection image data characterizing a forward projected image. The forward projection model (e.g., forward projection algorithm) may be any suitable forward projection model, such as any of the forward projection models described herein.

Based on the forward projection image data and the training set of image data, image reconstruction system 104 computes a loss value. Image reconstruction system 104 may compute the loss value based on any suitable loss function (e.g., loss algorithm), such as any loss function described herein.

Further, image reconstruction system 104 determines whether the machine learning model is trained based on the computed loss value. For instance, image reconstruction system 104 may determine whether the computed loss value is beyond (e.g., is greater than, is less than, etc.) a corresponding threshold. If the computed loss value is beyond the corresponding threshold, image reconstruction system 104 may determine the machine learning model is trained, and may store parameters characterizing the trained machine learning model as trained neural network data 153 within data repository 150. If the computed loss value is not beyond the corresponding threshold, image reconstruction system 104 may continue to train the machine learning model (e.g., with additional training sets of image data).

In some examples, image reconstruction system 104 computes an additional loss value based on the output image data generated by the executed untrained machine learning model and second output image data generated from an already trained machine learning model (i.e., the second machine learning model). The already trained machine learning model may be, for example, a trained convolutional neural network, such as a convolutional neural network conventionally trained. Further, image reconstruction system 104 may determine whether the machine learning model is trained based on the computed loss value and the computed additional loss value. For instance, image reconstruction system 104 may determine whether each of the computed loss value and the computed additional loss value are beyond corresponding thresholds. If the computed loss value and the computed additional loss value are beyond their corresponding thresholds, image reconstruction system 104 may determine the machine learning model is trained, and may store parameters characterizing the trained machine learning model as trained neural network data 153 within data repository 150. If any of the computed loss value and the computed additional loss value are not beyond their corresponding threshold, image reconstruction system 104 may continue to train the machine learning model (e.g., with additional training sets of image data).

In some examples image reconstruction system 104 performs operations to validate the machine learning model based on additional epochs of image data. For example, image reconstruction system 104 may input projection data (e.g., histo-images 115) to the initially trained and executed machine learning model which, in response, generates output image data. Image reconstruction system 104 may apply a forward projection process to the output image data and, based on the application of the forward projection process, may generate forward projection image data characterizing a forward projected image. Image reconstruction system 104 may then compute a loss value based on the additional epochs of image data and the forward projection image data, and may determine whether the initially trained and executed machine learning model is validated based on the computed loss value. In some instances, the image reconstruction system 104 may also compute an additional loss value based on the output image data and second output image data generated from the already trained machine learning model, and may determine whether the initially trained and executed machine learning model is validated based on the computed loss value and the computed additional loss value, as described herein.

Once trained and, in some examples, validated, image reconstruction system 104 may employ the machine learning model to reconstruct images. For example, image reconstruction system 104 may receive PET measurement data 111 from image scanning system 102. As described herein, Histo-image generation engine 113 may generate a histo-image 115 based on the PET measurement data 111. Further, image volume reconstruction engine 118 may apply the trained machine learning model to the histo-image 115 to generate the final image volume 191. In some instances, histo-image generation engine 113 includes a histogrammer that generates the histo-image 115 based on the PET measurement data 111.

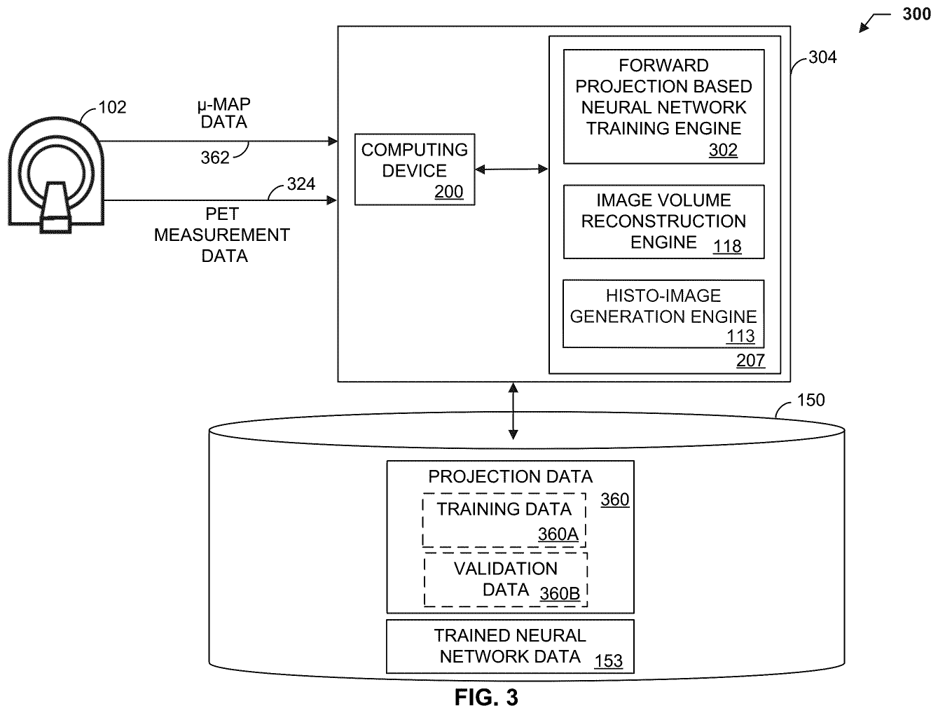

FIG. 3 illustrates an example of a nuclear imaging system 300 for training a machine learning model, such as a neural network, that when trained can receive projection data and, based on the projection data, generate final image volumes, such as the final image volume 191 of FIG. 1. In this example, image reconstruction system 304 includes executable instructions within instruction memory 207 includes forward projection based neural network training engine 302, image volume reconstruction engine 118, and histo-image generation engine 113. Further, nuclear imaging system 300 includes a computing device 200 communicatively coupled to the instruction memory 207, and is configured to execute any one or more of the forward projection based neural network training engine 302, image volume reconstruction engine 118, and histo-image generation engine 113.

As illustrated, nuclear imaging system 300 is communicatively coupled to data repository 150 and to image scanning system 102. Data repository 150 may store projection data 360, which may include training data 360A and/or validation data 360B, for instance. Training data 360A may include epochs of projection data (e.g., projection data in histo-image format) to be used for training a machine learning model. For example, the training data 360A may be generated based on PET measurement data 324 received from image scanning system 102. In some instances, training data 360A further includes corresponding attenuation maps. For example, the attenuation maps may be based on μ-map data 362 received from image scanning system 102. Validation data 360B may include epochs of image data to be used for validating (e.g., testing) an initially trained machine learning model. In some instances, training data 360A also includes corresponding attenuation maps. In some examples, training data 360A and validation data 360B include distinct epochs of image data.

As described herein, executed image volume reconstruction engine 118 may apply a trained machine learning process, such as a trained machine learning process based on a neural network, that can generate reconstructed images based on image data and, in some examples, corresponding attenuation maps. To train a machine learning model of the machine learning process of executed image volume reconstruction engine 118, such as a neural network that can generate reconstructed images, computing device 200 may execute forward projection based neural network training engine 302.

Executed forward projection based neural network training engine 302 may obtain training data 360A from data repository 150, and may generate features based on the training data 360A. Further, executed forward projection based neural network training engine 302 may input the features to an untrained machine learning model that, in response, generates output image data. Further, executed forward projection based neural network training engine 302 may apply a forward projection process to the output image data to generate forward projection image data characterizing a forward projected image. Executed forward projection based neural network training engine 302 may then compute a loss value based on the forward projection image data and the training data 360A used to generate the features inputted into the untrained machine learning model.

Based on the computed loss value, executed forward projection based neural network training engine 302 may determine whether the machine learning model is trained. For instance, executed forward projection based neural network training engine 302 may compare the loss value to a corresponding threshold value to determine if the loss value is beyond the corresponding threshold value. If the loss value is beyond the corresponding threshold value, executed forward projection based neural network training engine 302 may determine the machine learning model is trained, and may store parameters associated with the now trained machine learning model as trained neural network data 153 within data repository 150. Otherwise, if the loss value is not beyond the corresponding threshold value, the executed forward projection based neural network training engine 302 may perform operations to continue training the machine learning model.

In some instances, once the machine learning model is trained, executed forward projection based neural network training engine 302 may perform operations to validate the initially trained machine learning model. For example, executed forward projection based neural network training engine 302 may obtain validation data 360B from the data repository 150, and may generate features based on the validation data 360B. Further, executed forward projection based neural network training engine 302 may input the generated validation features to the initially trained machine learning model and, in response to the inputted validation features, generates additional output image data. Further, executed forward projection based neural network training engine 302 may apply the forward projection process to the additional output image data to generate additional forward projection image data characterizing an additional forward projected image. Executed forward projection based neural network training engine 302 may then compute an additional loss value based on the additional forward projection image data and the validation data 360B used to generate the additional features inputted into the initially trained machine learning model.

Based on the computed additional loss value, executed forward projection based neural network training engine 302 may determine whether the machine learning model is validated. For instance, executed forward projection based neural network training engine 302 may compare the additional loss value to a corresponding threshold value to determine if the additional loss value is beyond the corresponding threshold value. If the additional loss value is beyond the corresponding threshold value, executed forward projection based neural network training engine 302 may determine the machine learning model is trained and validated, and may store parameters associated with the now trained and validated machine learning model as trained neural network data 153 within data repository 150. Otherwise, if the additional loss value is not beyond the corresponding threshold value, the executed forward projection based neural network training engine 302 may perform operations to continue training, and validating, the machine learning model.

Once trained, image reconstruction system 304 may apply the trained machine learning model to histo-images generated from PET measurement data 324 and, in some examples, μ-map data 362, received from image scanning system 102 in response to scanning a patient. Based on application of the trained machine learning model to the PET measurement data 324 and, in some examples, the μ-map data 362, the executed trained machine learning model may generate final image volumes, such as the final image volume 191 of FIG. 1.

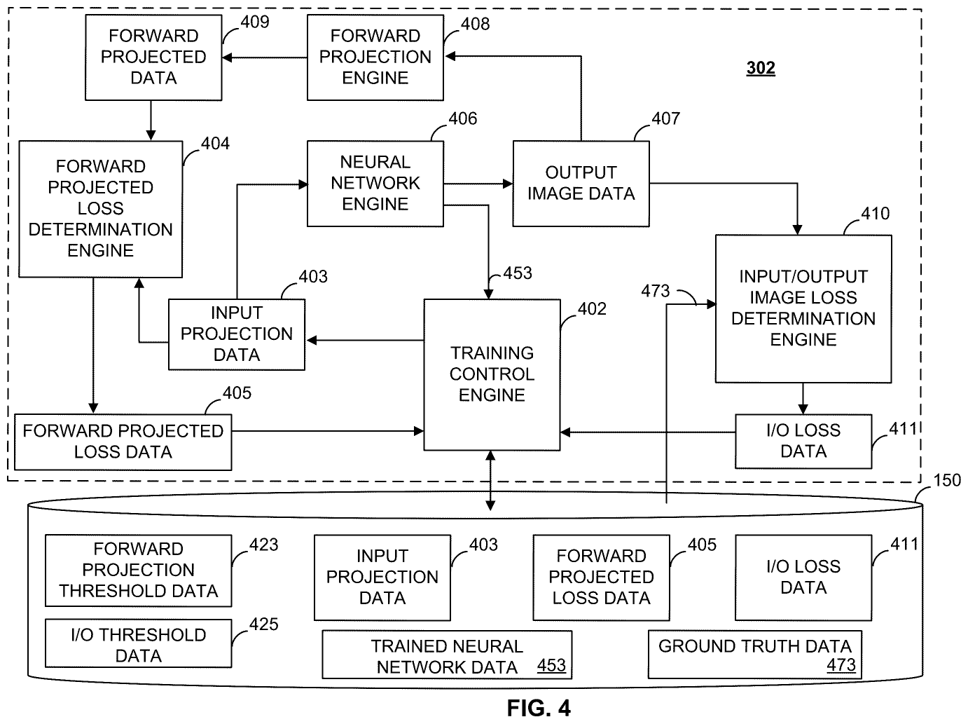

FIG. 4 illustrates an example of the forward projection based neural network training engine 302 of FIG. 3. In this example, a training control engine 402 obtains (e.g., receives) input projection data 403 from data repository 150, and provides (e.g., transmits) the input projection data 403 to neural network engine 406. Neural network engine 406 includes a neural network (e.g., a deep learning neural network such as a convolutional neural network) that is to be trained. Neural network engine 406 receives the input projection data 403, and generates input features based on the input projection data 403. Further, neural network engine 406 inputs the generated input features to the untrained machine learning model which, in response to the inputted features, generates output image data 407. Neural network engine 406 provides the output image data 407 to forward projection engine 408 and input/output image loss determination engine 410.

Forward projection engine 408 applies a forward projection process to the output image data 407 and, based on the forward projection process, generates forward projected data 409 characterizing a forward projected image. The forward projection process may be based on, for instance, a point-projection model, a convex-disk model, an area-weighted model, a Gaussian blobs model, a line-length model, a Rotation-based projection model, or any other suitable forward project model (e.g., physics model). In some examples, the forward projection model is a deep learning model that has learned to forward project image data.

Further, forward projected loss determination engine 404 receives the forward projected data 409 and the input projection data 403, and determines forward projected loss data 405 characterizing a first loss value. For instance, forward projected loss determination engine 404 may compute the first loss value based on any suitable loss function (e.g., image reconstruction loss function), such as any of the mean square error (MSE), mean absolute error (MAE), binary cross-entropy (BCE), Sobel, Laplacian, and Focal binary loss functions.

Input/output image loss determination engine 410 may receive the output image data 407 from neural network engine 406, and may further obtain ground truth data 473 from data repository 150. Ground truth data 473 may characterize ground truth data, such as out-of-network generated histo-images, for example. Further, input/output image loss determination engine 410 may generate I/O loss data 411 characterizing a second loss value based on the ground truth data 473 and the output image data 407. For instance, input/output image loss determination engine 410 may compute the second loss value based on applying any suitable loss function (e.g., image reconstruction loss function), such as any of the mean square error (MSE), mean absolute error (MAE), binary cross-entropy (BCE), Sobel, Laplacian, and Focal binary loss functions to the ground truth data 473 and the output image data 407.

Further, training control engine 402 may receive the forward projected loss data 405 and the I/O loss data 411, and determines whether the machine learning model is trained based on the forward projected loss data 405 and the I/O loss data 411. For instance, training control engine 402 may compare the forward projected loss data 405 and the I/O loss data 411 to corresponding thresholds, such as thresholds characterized by forward projection threshold data 423 and I/O threshold data 425, respectively, and stored in data repository 150, to determine if the machine learning model is trained. In some examples, training control engine 402 may store the forward projected loss data 405 and the I/O loss data 411 in data repository 150.

In some examples, training control engine 402 generates a final loss value based on the forward projected loss data 405 and the I/O loss data 411, and compares the final loss value to a corresponding threshold value to determine if the machine learning model is trained. For example, the final loss value may be the sum of the forward projected loss data 405 and the I/O loss data 411. In some instances, training control engine 402 applies a corresponding weight to each of the forward projected loss data 405 and the I/O loss data 411, and sums the results to compute the final loss value.

If the training control engine 402 determines the machine learning model is trained, the training control engine 402 obtains trained neural network data 453 from the neural network engine 406, which includes parameters associated with the trained machine learning model. The training control engine 402 then stores the trained neural network data 453 within data repository 150.

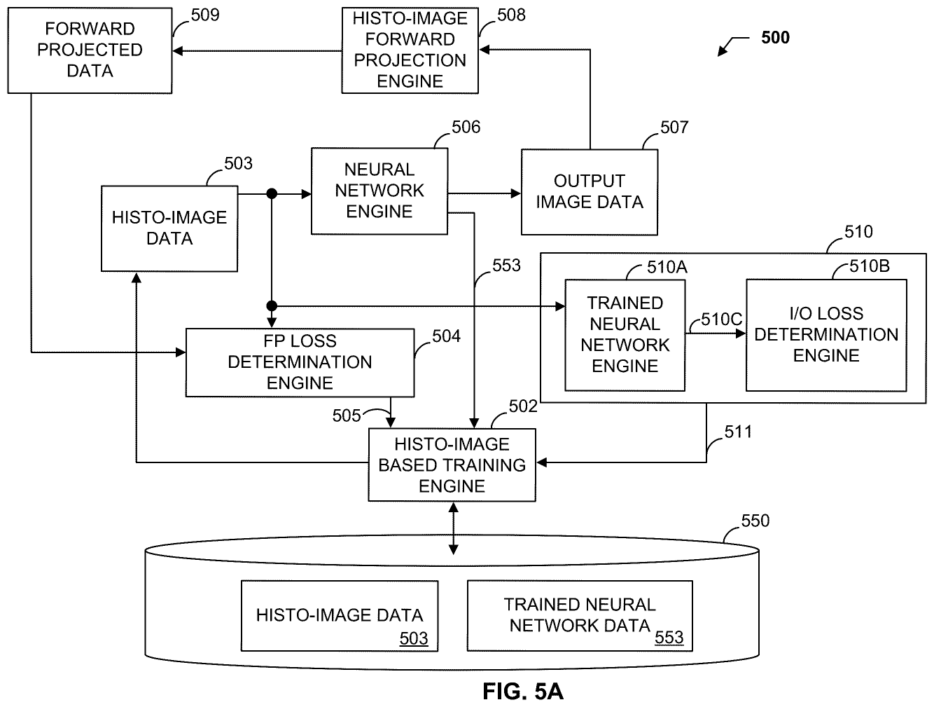

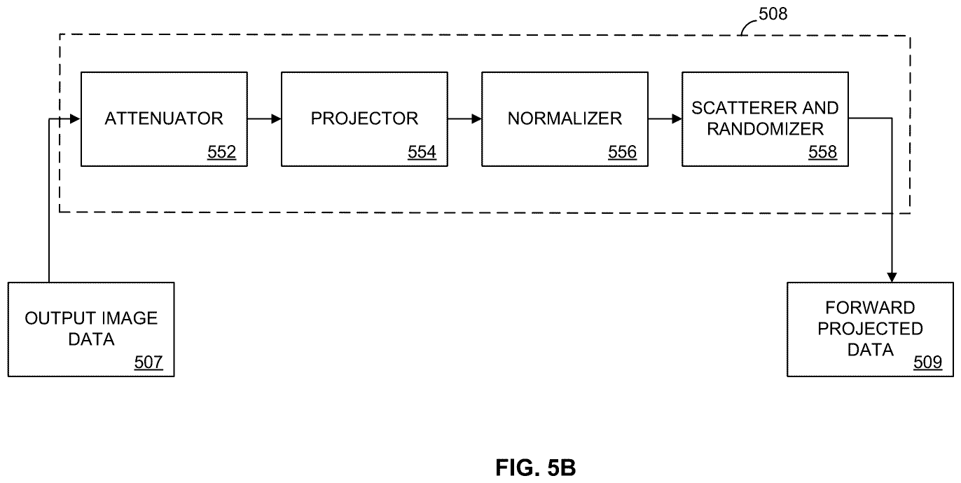

FIGS. 5A and 5B illustrate an example of a forward projection based neural network training system 500 that can train a machine learning model, such as a neural network, based on histo-image data (e.g., histo-images generated by a histogrammer). As illustrated, forward projection based neural network training system 500 includes histo-image based training engine 502, forward projection loss determination engine 504, neural network engine 506, histo-image forward projection engine 508, and additional loss determination engine 510. Each of histo-image based training engine 502, forward projection loss determination engine 504, neural network engine 506, histo-image forward projection engine 508, and additional loss determination engine 510 may be implemented in hardware, by one or more processors, such as processor 201, executing instructions, or in any suitable combination thereof.

Histo-image based training engine is operable to receive histo-image data 503 from data repository 550, and provide the histo-image data 503 to neural network engine 506. Histo-image data 503 may include histo-image data, as described herein. Further, neural network engine 506 may generate features based on the histo-image data 503, and may input the generated features to an untrained machine learning model which, in response to the inputted features, generates output image data 507. Neural network engine 506 provides the output image data 507 to histo-image forward projection engine 508.

Histo-image forward projection engine 508 applies a forward projection process to the output image data 507 and, based on the forward projection process, generates forward projected data 509 characterizing a forward projected histo-image. The forward projection process may be based on, for instance, a point-projection model, a convex-disk model, an area-weighted model, a Gaussian blobs model, a line-length model, a Rotation-based projection model, or any other suitable forward project model (e.g., physics model). In some examples, the forward projection model is a deep learning model that has learned to forward project histo-image data (e.g., histo-images).

For instance, FIG. 5B illustrates an example of histo-image forward projection engine 508. As illustrated, histo-image forward projection engine 508 may include an attenuator 552 that performs operations to attenuate output image data 507 and generate attenuated data. Further, a projector 554 performs operations to forward project the attenuated data (e.g., applies a forward projection process to the attenuated data) received from the attenuator 552, and provides the forward projected data to a normalizer 556. The normalizer 556 performs operations to normalize the forward projected data received from the projector 554, and provides normalized data to the scatterer and randomizer 558. The scatterer and randomizer 558 performs operations to the normalized data to correct for scatter and random coincidences, thereby generating the forward projected data 509. For instance, although not illustrated in FIG. 5B merely for clarity reasons, the scatterer and randomizer 558 may receive an attenuation map, such as attenuation map 105, and may perform operations to correct scatter and random coincidences of the normalized data based on the attenuation map.

Further, and with reference back to FIG. 5A, forward projection loss determination engine 504 receives the forward projected data 509 and the histo-image data 503, and determines forward projected loss data 505 characterizing a first loss value. For instance, forward projection loss determination engine 504 may compute the first loss value based on any suitable loss function (e.g., image reconstruction loss function), such as any of the mean square error (MSE), mean absolute error (MAE), binary cross-entropy (BCE), Sobel, Laplacian, and Focal binary loss functions.

Additional loss determination engine 510 may receive the histo-image data 503, and may apply a trained machine learning process to the histo-image data 503 to generate additional output image data. For instance, as illustrated, trained neural network engine 510A may apply a trained neural network process to the histo-image data 503 to generate the additional output image data 510C. The already trained neural network may be, for example, a trained convolutional neural network, such as a convolutional neural network conventionally trained. The trained neural network may be one that is trusted and/or used as a baseline neural network. Based on the additional output image data 510C and the histo-image data 503, I/O loss determination engine 510B of additional loss determination engine 510 may determine additional loss data 511 characterizing a second loss value. For instance, I/O loss determination engine 510B may compute the second loss value based on applying any suitable loss function (e.g., image reconstruction loss function), such as any of the mean square error (MSE), mean absolute error (MAE), binary cross-entropy (BCE), Sobel, Laplacian, and Focal binary loss functions to the histo-image data 503 and the additional output image data.

Further, histo-image based training engine 502 may receive the forward projected loss data 505 and the additional loss data 511, and determines whether the machine learning model is trained based on the forward projected loss data 505 and the additional loss data 511. For instance, histo-image based training engine 502 may compare the forward projected loss data 505 and the additional loss data 511 to corresponding thresholds to determine if the machine learning model is trained.

In some examples, histo-image based training engine 502 generates a final loss value based on the forward projected loss data 505 and the additional loss data 511, and compares the final loss value to a corresponding threshold value to determine if the machine learning model is trained. For example, the final loss value may be the sum of the forward projected loss data 505 and the additional loss data 511. In some instances, histo-image based training engine 502 applies a corresponding weight to each of the forward projected loss data 505 and the additional loss data 511, and sums the results to compute the final loss value.

If histo-image based training engine 502 determines the machine learning model is trained, histo-image based training engine 502 obtains trained neural network data 553 from the neural network engine 506, which includes parameters associated with the trained machine learning model. The histo-image based training engine 502 then stores the trained neural network data 553 within data repository 550.

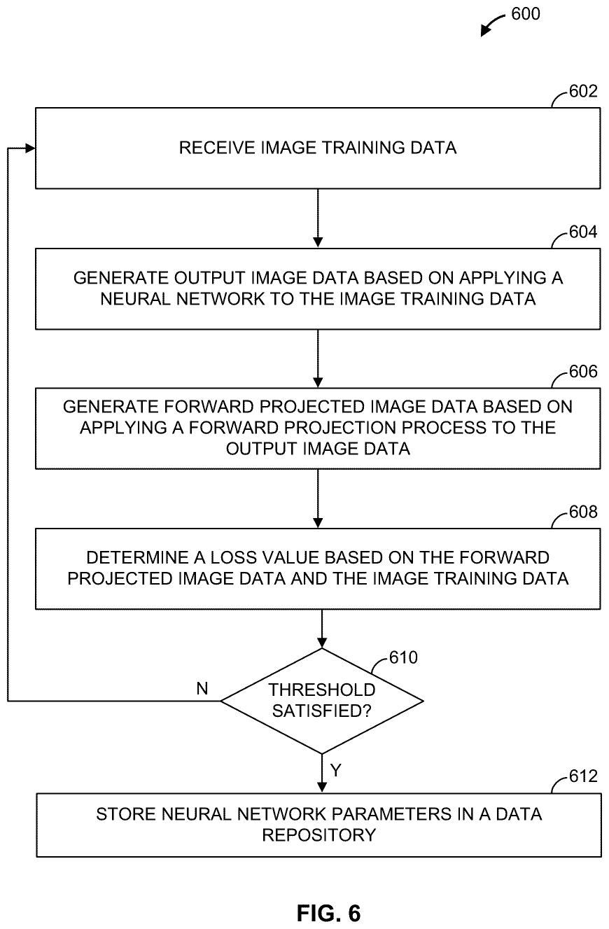

FIG. 6 is a flowchart of an example method 600 to train a neural network based on image data. The method can be performed by one or more computing devices, such as computing device 200, executing corresponding instructions.

Beginning at block 602, image training data is received. The image training data may be, for instance, projection data 403 (e.g., histo-images), or histo-image data 503. At block 604, a neural network is applied to the image training data and, based on the application of the neural network to the image training data, output image data is generated. For instance, and as described herein, features may be generated based on the image training data, and the features may be inputted to the neural network. Based on the inputted features, the neural network may generate the output image data.

Further, at block 606, forward projected image data is generated based on applying a forward projection process to the output image data. For example, the forward projection process may be based on a point-projection model, a convex-disk model, an area-weighted model, a Gaussian blobs model, a line-length model, a Rotation-based projection model, or any other suitable forward project model (e.g., physics model). In some examples, the forward projection model is a deep learning model that has learned to forward project image data. At block 608, a loss value is determined based on the forward projected image data and the image training data. For instance, the loss value may be computed based on a loss function, such as an MSE, MAE, BCE, Sobel, Laplacian, or Focal binary loss function.

Proceeding to block 610, a determination is made as to whether the determined loss value satisfies a threshold. For instance, the loss value may be compared to a corresponding threshold value to determine if the loss value is beyond (e.g., exceeds) the corresponding threshold. If the loss value is not beyond the corresponding threshold, the threshold is not satisfied and the method proceeds back to block 602 to continue training the neural network. If, however, the loss value is beyond the corresponding threshold, the threshold is satisfied and the method proceeds to block 612. At block 612, parameters associated with the now trained neural network (i.e., neural network parameters) are stored in a data repository. For instance, the parameters may be stored as trained neural network data 452 within data repository 150, or trained neural network data 553 within data repository 550. As described herein, the trained neural network may be established based on the stored parameters. Once established, the trained neural network may be employed to reconstruct images, such as PET images.

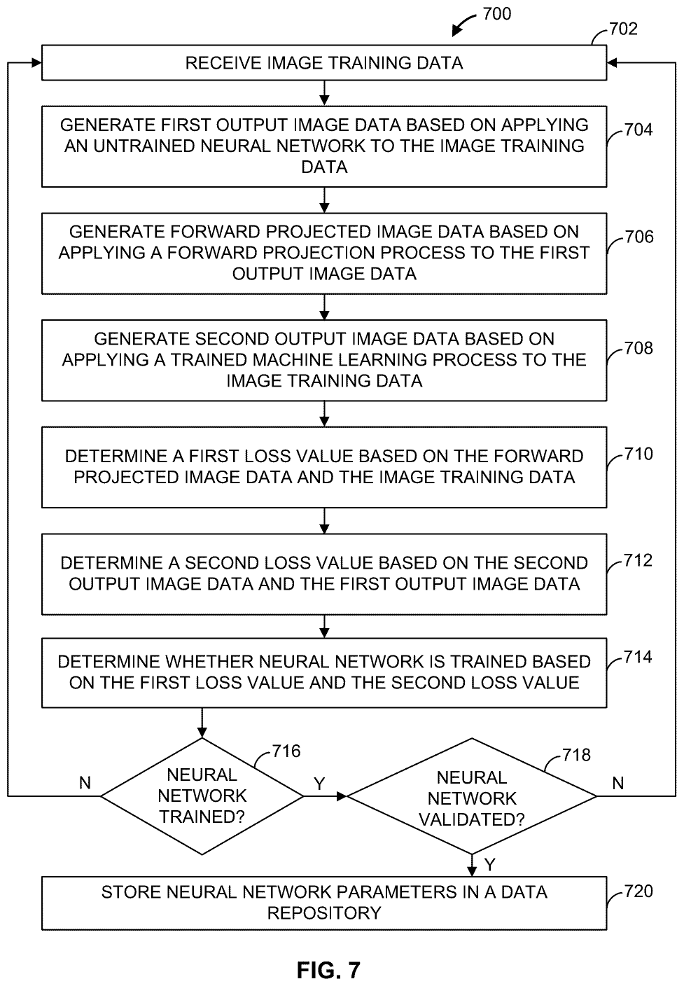

FIG. 7 is a flowchart of an example method 700 to train a neural network based on image data. The method can be performed by one or more computing devices, such as computing device 200, executing corresponding instructions.

Beginning at block 702, image training data is received. The image training data may be, for instance, projection data 403 (e.g., histo-images), or histo-image data 503. At block 704, a neural network is applied to the image training data and, based on the application of the neural network to the image training data, first output image data is generated. For instance, and as described herein, features may be generated based on the image training data, and the features may be inputted to the untrained neural network. Based on the inputted features, the untrained neural network may generate the first output image data.

Further, at block 706, forward projected image data is generated based on applying a forward projection process to the first output image data. For example, the forward projection process may be based on a point-projection model, a convex-disk model, an area-weighted model, a Gaussian blobs model, a line-length model, a Rotation-based projection model, or any other suitable forward project model (e.g., physics model). In some examples, the forward projection model is a deep learning model that has learned to forward project image data. At block 708, a trained machine learning process is applied to the image training data to generate second output image data. For example, as described herein, forward projection based neural network training system 500 may apply a trained neural network to histo-image data 503 to generate additional output image data 510C.

Proceeding to block 710, a first loss value is determined based on the forward projected image data and the image training data. For instance, the first loss value may be computed based on a loss function, such as an MSE, MAE, BCE, Sobel, Laplacian, or Focal binary loss function. At block 712, a second loss value is determined based on the second output image data and the first output image data. The second loss value may also be computed based on any suitable loss function. Further, and at block 714, a determination is made as to whether the neural network is trained based on the first loss value and the second loss value. For example, as described herein, each of the first loss value and the second loss value may be compared to corresponding threshold values, and the neural network may be considered trained if each of the first loss value and the second loss value exceed their corresponding thresholds. In some instances, a final loss value is computed based on the first loss value and the second loss value, and the neural network is considered trained when the final loss value exceeds a corresponding threshold value.

At block 716, if the neural network is not trained (e.g., the first loss value and the second loss value did not exceed their corresponding thresholds), the method proceeds back to block 702 to continue training the neural network (e.g., with additional epochs of image training data). If, however, the neural network is trained, the method proceeds to block 718.

Further, at block 718, the trained neural network is validated. For instance, blocks 702 through 714 may be performed to determine whether the trained neural network validates using additional epochs of image training data. If the trained neural network does not validate (e.g., the first loss value and/or the second loss value fail to exceed corresponding thresholds), the method proceeds back to block 702 to continue training the neural network. Otherwise, if the trained neural network validates, the method proceeds to block 720. At block 720, parameters associated with the now trained neural network (i.e., neural network parameters) are stored in a data repository. For instance, the parameters may be stored as trained neural network data 452 within data repository 150, or trained neural network data 553 within data repository 550. As described herein, the trained neural network may be established based on the stored parameters. Once established, the trained neural network may be employed to reconstruct images, such as PET images.

The following is a list of non-limiting illustrative embodiments disclosed herein:

Illustrative Embodiment 1: A computer-implemented method comprising:
receiving projection data;
applying a machine learning process to the projection data and, based on the application of the machine learning process to the projection data, generating output image data;
applying a forward projection process to the output image data and, based on the application of the forward projection process to the output image data, generating forward projected image data;
determining a loss value based on the forward projected image data and the projection data;
determining the machine learning process is trained based on the loss value; and
storing parameters associated with the machine learning process in a data repository.

Illustrative Embodiment 2: The computer-implemented method of illustrative embodiment 1, further comprising:
comparing the loss value to a threshold value; and
determining the machine learning process is trained based on the comparison.

Illustrative Embodiment 3: The computer-implemented method of any of illustrative embodiments 1-2, wherein the loss value is a first loss value, the computer-implemented method further comprising:
determining a second loss value based on the projection data and the output image data; and
determining the machine learning process is trained based on the first loss value and the second loss value.

Illustrative Embodiment 4: The computer-implemented method of illustrative embodiment 3, further comprising:
comparing the first loss value to a first threshold value;
comparing the second loss value to a second threshold value; and
determining the machine learning process is trained based on the comparisons.

Illustrative Embodiment 5: The computer-implemented method of any of illustrative embodiments 1-4, further comprising:
receiving positron emission tomography (PET) measurement data from an image scanning system; and
generating the projection data based on the PET measurement data, the projection data characterizing histo-images.

Illustrative Embodiment 6: The computer-implemented method of illustrative embodiment 5, further comprising applying the weighting values to an output of a similarity function.

Illustrative Embodiment 7: The computer-implemented method of any of illustrative embodiments 1-6, further comprising:
based on determining the machine learning process is trained:
receiving additional projection data;
applying the trained machine learning process to the additional projection data; and
based on the application of the trained machine learning process to the additional projection data, generating additional output image data, the additional output image data characterizing a final image volume.

Illustrative Embodiment 8: The computer-implemented method of any of illustrative embodiments 1-7, wherein applying the forward projection process to the output image data comprises:
generating attenuation data based on attenuating the output image data;
generating forward projected data based on forward projecting the attenuation data;
generating normalized data based on normalizing the forward projected data; and
generating the forward projected image data based on correcting the normalized data for scatter and random coincidences.

Illustrative Embodiment 9: The computer-implemented method of any of illustrative embodiments 1-8, wherein applying the forward projection process to the output image data comprises applying a trained deep learning process to the output image data.

Illustrative Embodiment 10: The computer-implemented method of any of illustrative embodiments 1-9, wherein the projection data characterizes histo-images.

Illustrative Embodiment 11: The computer-implemented method of any of illustrative embodiments 1-9, wherein the machine learning process is based on a deep learning neural network.

Illustrative Embodiment 12: A non-transitory computer readable medium storing instructions that, when executed by at least one processor, cause the at least one processor to perform operations comprising:
receiving projection data;
applying a machine learning process to the projection data and, based on the application of the machine learning process to the projection data, generating output image data;
applying a forward projection process to the output image data and, based on the application of the forward projection process to the output image data, generating forward projected image data;
determining a loss value based on the forward projected image data and the projection data;
determining the machine learning process is trained based on the loss value; and
storing parameters associated with the machine learning process in a data repository.

Illustrative Embodiment 13: The non-transitory, computer readable medium of illustrative embodiment 12 storing instructions that, when executed by the at least one processor, further cause the at least one processor to perform operations comprising:
comparing the loss value to a threshold value; and
determining the machine learning process is trained based on the comparison.

Illustrative Embodiment 14: The non-transitory, computer readable medium of any of illustrative embodiments 12-13, wherein the loss value is a first loss value, and wherein the instructions, when executed by the at least one processor, further cause the at least one processor to perform operations comprising:
determining a second loss value based on the projection data and the output image data; and
determining the machine learning process is trained based on the first loss value and the second loss value.

Illustrative Embodiment 15: The computer-implemented method of illustrative embodiment 14, further comprising:
comparing the first loss value to a first threshold value;
comparing the second loss value to a second threshold value; and
determining the machine learning process is trained based on the comparisons.

Illustrative Embodiment 16: The non-transitory, computer readable medium of any of illustrative embodiments 12-15 storing instructions that, when executed by the at least one processor, further cause the at least one processor to perform operations comprising:
receiving positron emission tomography (PET) measurement data from an image scanning system; and
generating the projection data based on the PET measurement data, the projection data characterizing histo-images.

Illustrative Embodiment 17: The non-transitory, computer readable medium of illustrative embodiment 16 storing instructions that, when executed by the at least one processor, further cause the at least one processor to perform operations comprising applying the weighting values to an output of a similarity function.

Illustrative Embodiment 18: The non-transitory, computer readable medium of any of illustrative embodiments 12-17 storing instructions that, when executed by the at least one processor, further cause the at least one processor to perform operations comprising:
based on determining the machine learning process is trained:
receiving additional projection data;
applying the trained machine learning process to the additional projection data; and
based on the application of the trained machine learning process to the additional projection data, generating additional output image data, the additional output image data characterizing a final image volume.

Illustrative Embodiment 19: The non-transitory, computer readable medium of any of illustrative embodiments 12-18, wherein applying the forward projection process to the output image data comprises:
generating attenuation data based on attenuating the output image data;
generating forward projected data based on forward projecting the attenuation data;
generating normalized data based on normalizing the forward projected data; and
generating the forward projected image data based on correcting the normalized data for scatter and random coincidences.

Illustrative Embodiment 20: The non-transitory, computer readable medium of any of illustrative embodiments 12-19 wherein applying the forward projection process to the output image data comprises applying a trained deep learning process to the output image data.

Illustrative Embodiment 21: The non-transitory, computer readable medium of any of illustrative embodiments 12-20, wherein the projection data characterizes histo-images.

Illustrative Embodiment 22: The non-transitory, computer readable medium of any of illustrative embodiments 12-21, wherein the machine learning process is based on a deep learning neural network.

Illustrative Embodiment 22: A system comprising:
a database; and
at least one processor communicatively coupled to the database and configured to:
   receive projection data;
   apply a machine learning process to the projection data and, based on the application of the machine learning process to the projection data, generating output image data;
   apply a forward projection process to the output image data and, based on the application of the forward projection process to the output image data, generating forward projected image data;
   determine a loss value based on the forward projected image data and the projection data;
   determine the machine learning process is trained based on the loss value; and
   store parameters associated with the machine learning process in the data repository.

Illustrative Embodiment 23: The system of illustrative embodiment 22, wherein the at least one processor is configured to:
compare the loss value to a threshold value; and
determine the machine learning process is trained based on the comparison.

Illustrative Embodiment 24: The system of any of illustrative embodiments 22-23, wherein the loss value is a first loss value, and wherein the at least one processor is configured to:
determine a second loss value based on the projection data and the output image data;
and determine the machine learning process is trained based on the first loss value and the second loss value.

Illustrative Embodiment 25: The system of illustrative embodiment 24, wherein the at least one processor is configured to:
compare the first loss value to a first threshold value;
compare the second loss value to a second threshold value; and
determine the machine learning process is trained based on the comparisons.

Illustrative Embodiment 26: The system of any of illustrative embodiments 22-25, wherein the at least one processor is configured to:
receive positron emission tomography (PET) measurement data from an image scanning system; and
generate the projection data based on the PET measurement data, the projection data characterizing histo-images.

Illustrative Embodiment 27: The system of illustrative embodiment 26, wherein the at least one processor is configured to apply the weighting values to an output of a similarity function.

Illustrative Embodiment 28: The system of any of illustrative embodiments 22-27, wherein the at least one processor is configured to:
based on determining the machine learning process is trained:
receive additional projection data;
apply the trained machine learning process to the additional projection data; and
based on the application of the trained machine learning process to the additional projection data, generate additional output image data, the additional output image data characterizing a final image volume.

Illustrative Embodiment 29: The system of any of illustrative embodiments 22-28, wherein to apply the forward projection process to the output image data, the at least one processor is configured to:
generate attenuation data based on attenuating the output image data;
generate forward projected data based on forward projecting the attenuation data;
generate normalized data based on normalizing the forward projected data; and
generate the forward projected image data based on correcting the normalized data for scatter and random coincidences.

Illustrative Embodiment 30: The system of any of illustrative embodiments 22-29, wherein to apply the forward projection process to the output image data, the at least one processor is configured to apply a trained deep learning process to the output image data.

Illustrative Embodiment 31: The system of any of illustrative embodiments 22-30, wherein the projection data characterizes histo-images.

Illustrative Embodiment 32: The system of any of illustrative embodiments 22-31, wherein the machine learning process is based on a deep learning neural network.

Illustrative Embodiment 33: A system comprising:
a means for receiving projection data;
a means for applying a machine learning process to the projection data and, based on the application of the machine learning process to the projection data, generating output image data;
a means for applying a forward projection process to the output image data and, based on the application of the forward projection process to the output image data, generating forward projected image data;
a means for determining a loss value based on the forward projected image data and the projection data;
a means for determining the machine learning process is trained based on the loss value; and
a means for storing parameters associated with the machine learning process in the datarepository.

Illustrative Embodiment 34: The system of illustrative embodiment 33, comprising:
a means for comparing the loss value to a threshold value; and
a means for determining the machine learning process is trained based on the comparison.

Illustrative Embodiment 35: The system of any of illustrative embodiments 33-34, wherein the loss value is a first loss value, the system comprising:
a means for determining a second loss value based on the projection data and the output image data; and
a means for determining the machine learning process is trained based on the first loss value and the second loss value.

Illustrative Embodiment 36: The system of illustrative embodiment 35, comprising:
a means for comparing the first loss value to a first threshold value;
a means for comparing the second loss value to a second threshold value; and
a means for determining the machine learning process is trained based on the comparisons.

Illustrative Embodiment 37: The system of any of illustrative embodiments 33-36, comprising:
a means for receiving positron emission tomography (PET) measurement data from an image scanning system; and
a means for generating the projection data based on the PET measurement data, the projection data characterizing histo-images.

Illustrative Embodiment 38: The system of illustrative embodiment 37, the system comprising a means for applying the weighting values to an output of a similarity function.

Illustrative Embodiment 39: The system of any of illustrative embodiments 33-38, comprising:
based on determining the machine learning process is trained:
a means for receiving additional projection data;
a means for applying the trained machine learning process to the additional projection data; and
based on the application of the trained machine learning process to the additional projection data, a means for generating additional output image data, the additional output image data characterizing a final image volume.

Illustrative Embodiment 40: The system of any of illustrative embodiments 33-39, wherein to apply the forward projection process to the output image data, the system comprises:
a means for generating attenuation data based on attenuating the output image data;
a means for generating forward projected data based on forward projecting the attenuation data;
a means for generating normalized data based on normalizing the forward projected data; and
a means for generating the forward projected image data based on correcting the normalized data for scatter and random coincidences.

Illustrative Embodiment 41: The system of any of illustrative embodiments 33-40, wherein to apply the forward projection process to the output image data, the system comprises a means for applying a trained deep learning process to the output image data.

Illustrative Embodiment 42: The system of any of illustrative embodiments 33-41, wherein the projection data characterizes histo-images.

Illustrative Embodiment 43: The system of any of illustrative embodiments 33-42, wherein the machine learning process is based on a deep learning neural network.

The apparatuses and processes are not limited to the specific embodiments described herein. In addition, components of each apparatus and each process can be practiced independent and separate from other components and processes described herein.

The previous description of embodiments is provided to enable any person skilled in the art to practice the disclosure. The various modifications to these embodiments will be readily apparent to those skilled in the art, and the generic principles defined herein can be applied to other embodiments without the use of inventive faculty. The present disclosure is not intended to be limited to the embodiments shown herein, but is to be accorded the widest scope consistent with the principles and novel features disclosed herein.

What is claimed is:

1. A computer-implemented method comprising:
receiving projection data;
applying a machine learning process to the projection data and, based on the application of the machine learning process to the projection data, generating output image data;
applying a forward projection process to the output image data and, based on the application of the forward projection process to the output image data, generating forward projected image data;
determining a loss value based on the forward projected image data and the projection data;
determining the machine learning process is trained based on the loss value; and
storing parameters associated with the machine learning process in a data repository.

2. The computer-implemented method of claim 1, further comprising: comparing the loss value to a threshold value; and
determining the machine learning process is trained based on the comparison.

3. The computer-implemented method of claim 1, wherein the loss value is a first loss value, the computer-implemented method further comprising:
determining a second loss value based on the projection data and the output image data; and
determining the machine learning process is trained based on the first loss value and the second loss value.

4. The computer-implemented method of claim 3, further comprising: comparing the first loss value to a first threshold value;
comparing the second loss value to a second threshold value; and
determining the machine learning process is trained based on the comparisons.

5. The computer-implemented method of claim 1, further comprising:
receiving positron emission tomography (PET) measurement data from an image scanning system; and
generating the projection data based on the PET measurement data, the projection data characterizing histo-images.

6. The computer-implemented method of claim 5, further comprising: receiving an attenuation map from the image scanning system;
applying the machine learning process to the projection data and the attenuation map; and
generating the output image data based on the application of the machine learning process to the projection data and the attenuation map.

7. The computer-implemented method of claim 1, further comprising: based on determining the machine learning process is trained:
receiving additional projection data;
applying the trained machine learning process to the additional projection data; and
based on the application of the trained machine learning process to the additional projection data, generating additional output image data, the additional output image data characterizing a final image volume.

8. The computer-implemented method of claim 1, wherein applying the forward projection process to the output image data comprises:
generating attenuation data based on attenuating the output image data;
generating forward projected data based on forward projecting the attenuation data;
generating normalized data based on normalizing the forward projected data; and
generating the forward projected image data based on correcting the normalized data for scatter and random coincidences.

9. The computer-implemented method of claim 1, wherein applying the forward projection process to the output image data comprises applying a trained deep learning process to the output image data.

10. The computer-implemented method of claim 1, wherein the projection data characterizes histo-images.

11. The computer-implemented method of claim 1, wherein the machine learning process is based on a deep learning neural network.

12. A non-transitory computer readable medium storing instructions that, when executed by at least one processor, cause the at least one processor to perform operations comprising:
receiving projection data;
applying a machine learning process to the projection data and, based on the application of the machine learning process to the projection data, generating output image data;
applying a forward projection process to the output image data and, based on the application of the forward projection process to the output image data, generating forward projected image data;
determining a loss value based on the forward projected image data and the projection data;
determining the machine learning process is trained based on the loss value; and
storing parameters associated with the machine learning process in a data repository.

13. The non-transitory computer readable medium of claim 12 storing instructions that, when executed by at least one processor, further cause the at least one processor to perform operations comprising:
comparing the loss value to a threshold value; and
determining the machine learning process is trained based on the comparison.

14. The non-transitory computer readable medium of claim 12, wherein the loss value is a first loss value, and the non-transitory computer readable medium storing instructions that, when executed by at least one processor, further cause the at least one processor to perform operations comprising:
determining a second loss value based on the projection data and the output image data; and
determining the machine learning process is trained based on the first loss value and the second loss value.

15. The non-transitory computer readable medium of claim 14 storing instructions that, when executed by at least one processor, further cause the at least one processor to perform operations comprising:
comparing the first loss value to a first threshold value;
comparing the second loss value to a second threshold value; and
determining the machine learning process is trained based on the comparisons.

16. The non-transitory computer readable medium of claim 12 storing instructions that, when executed by at least one processor, further cause the at least one processor to perform operations comprising:
receiving an attenuation map from the image scanning system;
applying the machine learning process to the projection data and the attenuation map; and
generating the output image data based on the application of the machine learning process to the projection data and the attenuation map.

17. The non-transitory computer readable medium of claim 12, wherein the projection data characterizes histo-images.

18. A system comprising:
a database; and
at least one processor communicatively coupled to the database and configured to:
receive projection data;
apply a machine learning process to the projection data and, based on the application of the machine learning process to the projection data, generating output image data;
apply a forward projection process to the output image data and, based on the application of the forward projection process to the output image data, generating forward projected image data;
determine a loss value based on the forward projected image data and the projection data;
determine the machine learning process is trained based on the loss value; and
store parameters associated with the machine learning process in the data repository.

19. The system of claim 18, wherein the at least one processor is configured to: compare the loss value to a threshold value; and
determine the machine learning process is trained based on the comparison.

20. The system of claim 18, wherein the loss value is a first loss value, and wherein the at least one processor is configured to:
determine a second loss value based on the projection data and the output image data; and
determine the machine learning process is trained based on the first loss value and the second loss value.
